(19) United States
(12) Patent Application Publication
(10) Pub. No.: US 2026/0233919 A1
(43) Pub. Date: Aug. 13, 2026

(54) LIGHT SHIELD BIOPROCESSING BAGS

(71) Applicant: ARAN BIOTECH LTD., Kibbutz Nachshon (IL)

(72) Inventor: Sarel CHEN TOV, Kfar Sirkin (IL)

(21) Appl. No.: 19/150,654

(22) PCT Filed: Jan. 23, 2024
(86) PCT No.: PCT/IL2024/050093

§ 371 Date: Jul. 24, 2025

Related U.S. Application Data
(60) Provisional application No. 63/440,711, filed on Jan. 24, 2023.

(51) Int. Cl. B65D 81/30; A61J 1/10; B65D 75/52; B65D 75/58

(52) U.S. Cl. CPC B65D 81/30; A61J 1/10; B65D 75/522; B65D 75/5877

(57) ABSTRACT

A bioprocess bag, for containing and protecting fluids involved in bioprocesses, the bag comprising: at least two films that are bonded together along edges to form a bag; and a fluid port through which to flow fluid into or out from the bag; wherein at least one of the films is a band-stop film comprising a band-stop layer characterized by an electromagnetic (EM) transmission profile in at least a portion of the band-stop layer that blocks transmission in a selected EM bandwidth of EM radiation expected to be encountered in an ambient environment in which the bioprocess bag is to function that is inimical to a bioprocess liquid intended to be contained in the bag.

### RELATED APPLICATIONS

The present application claims the benefit under 35 U.S.C. 119€ of U.S. Provisional Application 63/440,711 filed on Jan. 24, 2023, the disclosure of which is incorporated herein by reference.

### FIELD

Embodiments of the disclosure relate to providing single use bioprocess bags.

### BACKGROUND

Bioprocess bags are flexible, generally one time use bags for containing and protecting the physical and chemical integrity of liquids involved in bioprocesses. Typically a bioprocess bag is constructed from multilayer films that are bonded together along edges of a bag they form. Each of the layers, optionally referred to generically as bioprocess layers, in the multilayer films operates to aid in maintaining integrity of the liquid the bag contains and contributes to the physical and/or chemical isolation of the liquid from an ambient environment of a bioprocess in which the liquid participates.

By way of example a bioprocess bag may be formed from a multilayer film comprising: an outer “abuse layer” configured to be in direct physical contact with an ambient environment of a bioprocess in which the bag is used; a barrier layer that functions to block undesirable transmission of a fluid, for example oxygen, through the film; and an interior contact layer that is configured to be in direct physical contact with a bioprocess liquid that the bag is to contain. The film generally comprises tie layers between other layers of the film that facilitate adhesion of the layers to each other. The outer abuse layer is typically formed from a polyethylene, nylon, or polyester, and the inner contact layer from a low, linear low, or ultralow density polyethylene (LDPE, LLDPE, or ULDPE).

### SUMMARY

An aspect of an embodiment of the disclosure relates to providing a bioprocess bag that is configured to block electromagnetic (EM) radiation in a selected wavelength band that illuminates at least a portion of the bag from penetrating the bag to illuminate a bioprocess liquid that the bag contains.

In an embodiment the bag is formed from a bioprocess film, hereinafter also referred to as a band-stop film, that comprises a band-stop layer in addition to conventional bioprocess layers advantageous for use in a given bioprocess from which the bag is to be used. The band-stop layer is characterized by an EM transmission profile in at least a portion of the band-stop layer that blocks transmission of the electromagnetic radiation in the selected EM bandwidth. Optionally, the characterizing EM transmission profile of the band-stop layer characterizes all of the band-stop layer.

In an embodiment, the characterizing EM transmission profile has a relatively high reflectivity for EM radiation in a relatively wide bandwidth of EM radiation that is expected to be encountered in an ambient environment in which the bioprocess bag is to function. In an embodiment the band-stop layer operates as a band-pass layer characterized by a transmission profile having a relatively high transmissivity for EM radiation in a relatively narrow band-pass window and a relatively low transmissivity for EM radiation outside the band-pass window.

In an embodiment the band-stop layer is an external band-stop layer laminated to a side of an abuse layer of the conventional layers of the band-stop film that, absent the band-stop layer, would be directly exposed to the ambient environment of the bioprocess in which the bag is used. In an embodiment the external band-stop layer is formed having a flap-like region, hereinafter referred to as a “flap-door”, that may be mechanically, optionally manually, relatively easily lifted off of the abuse layer to which the band-stop layer is laminated to enable visual observation of contents of the bag. In an embodiment the band-stop layer is an internal layer of the band-stop film.

In an embodiment the bag is formed from band-stop films characterized by different EM transmission profiles. In an embodiment a portion of the transmission profile of the band-stop film relevant to the bioprocess in which the bag is used is a function of wavelengths in at least a portion of the visual spectrum. Optionally, the bag is a 2D bag. In an embodiment the bag is a 3D bag.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

Non-limiting examples of embodiments of the disclosure are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A-1G schematically illustrate production of a band-stop bioprocess bag in accordance with an embodiment of the disclosure; and

FIGS. 2A-2D schematically illustrate stages in production of a band-stop bioprocess bag, in accordance with an embodiment of the disclosure.

### DETAILED DESCRIPTION

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment in an application for which it is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily required, configuration of possible embodiments of the disclosure. Each of the verbs, “comprise” “include” and “have”, and conjugates thereof, are used to indicate that the object or objects of the verb are not necessarily a complete listing of components, elements or parts of the subject or subjects of the verb. Unless otherwise indicated, the word “or” in the description and claims is considered to be the inclusive “or” rather than the exclusive or, and indicates at least one of, or any combination of more than one of items it conjoins.

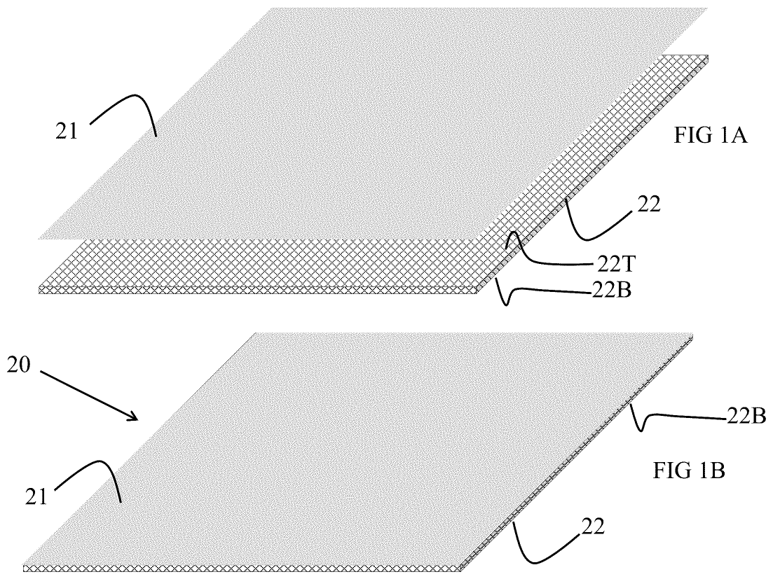

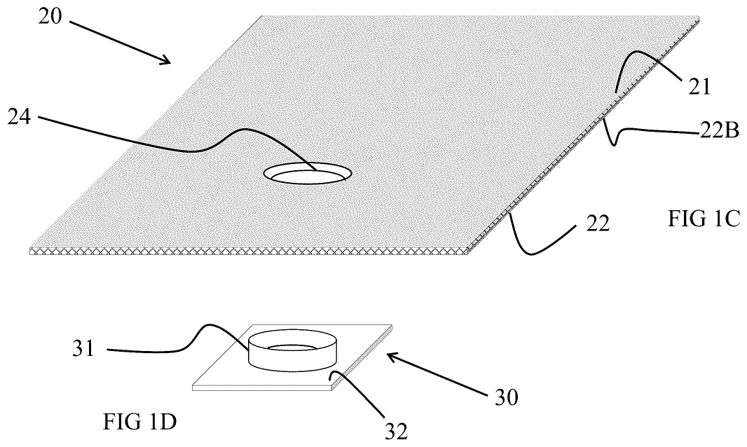

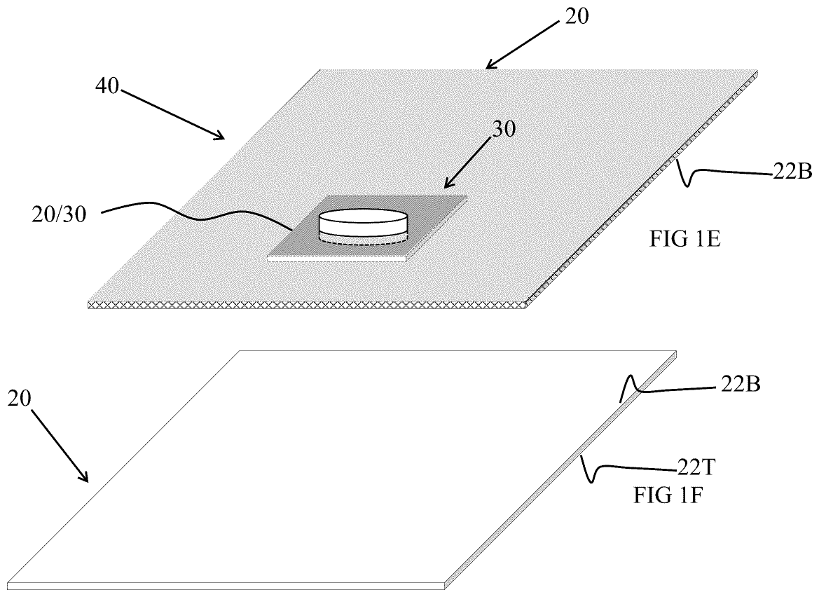

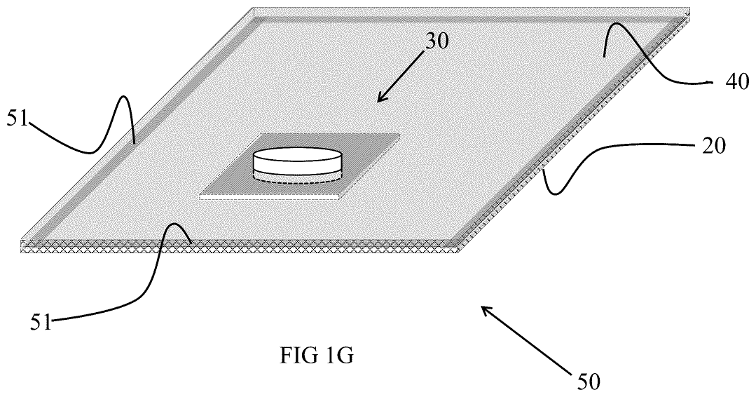

FIG. 1A-1G schematically illustrates stages in a process for producing a bioprocess bag in accordance with an embodiment of the disclosure.

FIG. 1A schematically shows a band-stop layer 21 characterized by a characteristic transmission profile aligned to be laminated to a bioprocess film 22 substantially transparent to visible light, to form a band-stop film for use in forming a bioprocess bag, in accordance with an embodiment of the disclosure. Bioprocess film 22 is assumed to be a multilayer laminate of bioprocess layers, that is substantially transparent, optionally to light in the visible spectrum. Whereas the bioprocess layers comprised in bioprocess film 22 are not explicitly designated and shown in FIGS. 1A-1G, a top surface 22T of the bioprocess film is assumed to be a surface of the abuse layer of the film and a bottom surface 22B of the film is assumed to be a surface of the contact layer of the film. Band-stop layer 21 shown in FIG. 1A is assumed aligned to be laminated to surface 22T of the abuse layer of bioprocess film 22. FIG. 1B schematically shows band-stop layer 21 after it has been laminated to surface 22T of bioprocess film 22 to form a band-stop film 20, in accordance with an embodiment of the disclosure.

In an embodiment, band-stop layer 21 is a homogeneous layer characterized by a spatially substantially uniform transmission profile having a standard deviation, equal by way of example, to about 10%. Optionally, the transmission profile is highly reflective for EM radiation having a wavelength in a wavelength band of the visible spectrum. Optionally, the wavelength band substantially spans the visible spectrum. In an embodiment the transmission profile is characterized by reflectivity for light in the wavelength band that is greater than about 90%. In an embodiment the spatially uniform transmission profile is characterized by a bandpass in a portion of the visible spectrum that enables light, also referred to as benign light, that is not detrimental to a bioprocess liquid intended to be contained in a bioprocess bag made from band-stop film 20 to pass through the band-stop layer. In an embodiment, the transmission profile is configured so that in a limited region, optionally referred to as a band-pass aperture, of band-stop layer 21 the band-stop layer is substantially transparent to benign light. Optionally, the benign light is light in a portion of the visible spectrum between about 530 nm (nanometers) and about 700 nm.

In FIG. 1C band-stop film 20 has a hole 24 cut through the band-stop film to receive and be bonded to a fluid port 30 schematically shown in FIG. 1D. Fluid port 30 comprises a spigot 31 and a flange 32. Hole 24 is dimensioned to receive spigot 31 and flange 32 is configured to be bonded to bottom surface 22B of bioprocess film 22. FIG. 1E schematically shows fluid port 30 after spigot 31 has been inserted through hole 24 and flange 32 bonded to surface 22B to form a port panel 40 of a bioprocess bag in accordance with an embodiment of the disclosure. Dark shaded region 20/30 schematically represent a join material, such as material of a tie layer optionally used to bond flange 32 to surface 22B. A back panel of the bioprocess bag is optionally a band-stop film 20 shown in FIG. 1F below panel 40 and having bottom surface 22B of the band-stop film facing bottom surface 22B of panel 40 so that the contact layers of panel 40 and panel 20 may be bonded together along their edges to form an optionally 2D bioprocess bag.

FIG. 1G schematically shows port panel 40 and back panel 20 having their bottom, contact surfaces 22B (FIG. 1F) bonded along their respective edges to from a 2D bioprocess bag 50 in accordance with an embodiment of the disclosure. Dark-shaded regions 51 along the edges of the panels indicate regions at which the panels are bonded.

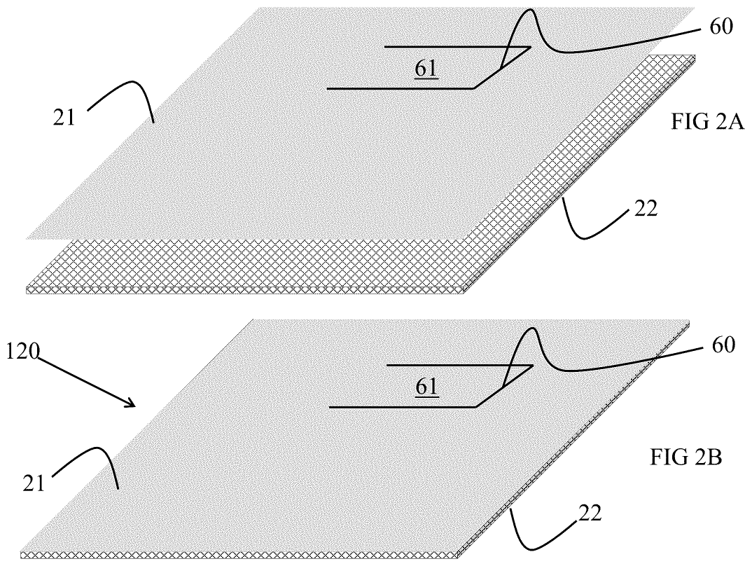

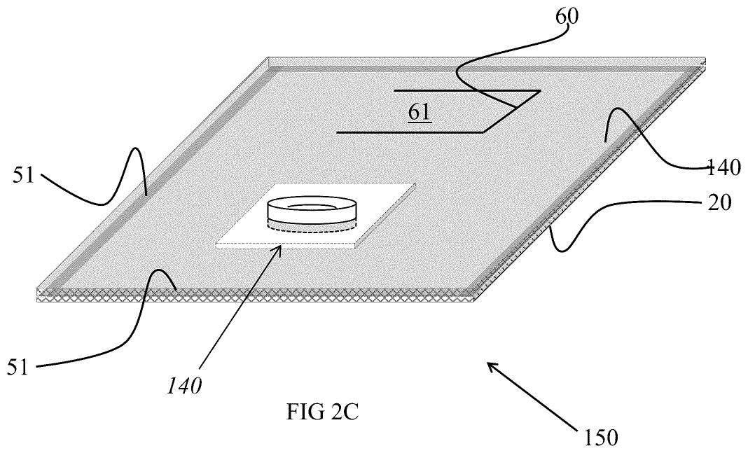

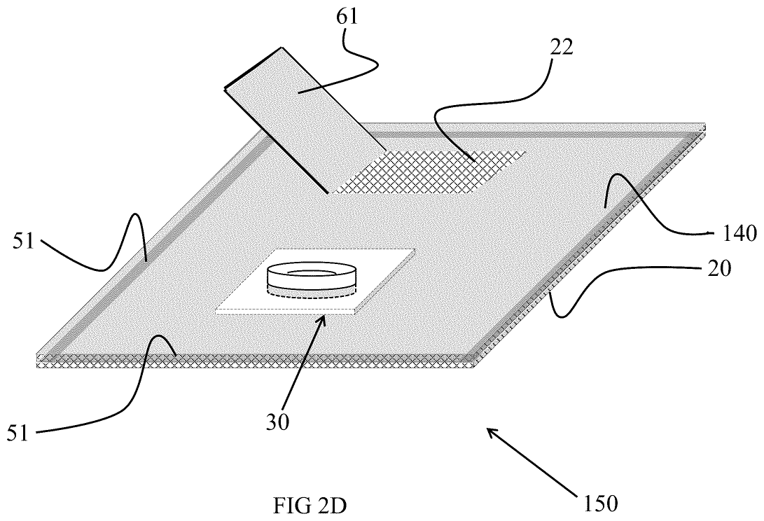

FIGS. 2A-2D schematically illustrate stages in producing a flap-door bioprocessing bag in accordance with an embodiment of the disclosure. FIG. 2A schematically shows a band-stop layer 21 aligned to be mounted and laminated to a bioprocess film 22 to form a band-stop film 120 in accordance with an embodiment of the disclosure schematically shown in FIG. 2B. Band-stop layer 21 is cut through along a cut line 60 to form a flap-door 61. Flap-door 61 is not bonded to bioprocess film 22 during lamination of band-stop layer 21 to bioprocess film, 22 and may be held in place on the bioprocess layer so that it may be, optionally manually, relatively easily lifted off from the bioprocess layer. Optionally, flap-door 61 is held in place by patches of a hook and loop fastener (not shown).

FIG. 2C schematically shows a 2D bioprocess bag 150 formed from a fluid port panel 140 comprising a fluid port 30 mounted to band-stop film 120 (FIG. 2B) bonded to a back panel 20. Fluid port panel 140 is similar to fluid port panel 40 (FIG. 1E) and has a fluid port 30 mounted to band-stop film 120 (FIG. 2B) but comprises in addition flap-door 61. Flap-door 61 may be “opened” to expose a region of transparent bioprocess film 22 so that contents of bioprocess bag 150 may be visually observed. FIG. 2D schematically shows bioprocess bag 150 having flap-door lifted off bioprocess film 22 to enable visual observation of contents of the bag.

There is therefore provided in accordance with an embodiment of the disclosure a bioprocess bag, for containing and protecting fluids involved in bioprocesses, the bag comprising: at least two films that are bonded together along edges to form a bag; and a fluid port through which to flow fluid into or out from the bag; wherein at least one of the films is a band-stop film comprising a band-stop layer characterized by an electromagnetic (EM) transmission profile in at least a portion of the band-stop layer that blocks transmission in a selected EM bandwidth of EM radiation expected to be encountered in an ambient environment in which the bioprocess bag is to function that is inimical to a bioprocess liquid intended to be contained in the bag. Optionally, the EM transmission profile has a relatively high reflectivity for EM radiation in the selected EM bandwidth. Additionally, or alternatively, the EM transmission profile has a relatively low transmissivity for EM radiation in the selected EM bandwidth. In an embodiment, the EM transmission profile has . a relatively high transmissivity for EM radiation in a band-pass window for which EM radiation is not inimical to the bioprocess liquid. Optionally, the non-inimical EM radiation comprises optical radiation in the visible spectrum. In an embodiment, the EM transmission profile has a relatively high transmissivity for EM radiation in a relatively narrow band-pass window for which EM radiation is inimical to the bioprocess liquid. In an embodiment, the inimical radiation EM comprises optical radiation in the visible spectrum.

In an embodiment, the band-stop film comprising the band-stop layer is a multilayer band-stop film. Optionally, the band-stop layer is laminated to a surface of a layer in the multilayer band-stop film. Optionally, the band stop layer is an internal layer of the multiplayer band-stop film. In an embodiment, the surface is a surface, which absent the band-stop layer would be an external surface of the bag. Optionally, the band-stop layer is formed having a flap door configured to be relatively easily mechanically lifted off from and reattached onto the external surface.

In an embodiment, the at least a portion comprises all of the band-stop layer. In an embodiment, the the fluid port is bonded to the band-stop film.

There is further provided in accordance with an embodiment of the disclosure a a band-stop film characterized by an electromagnetic (EM) transmission profile in at least a portion of the band-stop layer that blocks transmission of EM radiation in a selected EM bandwidth. of EM radiation expected to be encountered in an ambient environment in which the film is to function that is inimical to a bioprocess liquid intended with which the film is to be used. Optionally, the band-stop film comprising the band-stop layer is a multilayer band-stop film. Optionally, the band-stop layer is laminated to a surface of a layer in the multilayer band-stop film. Optionally, the band stop layer is an internal layer of the multiplayer band-stop film. Optionally, the surface is a surface, which absent the band-stop layer would be an external surface of the multiplayer band-stop film. Optionally, the band-stop layer is formed having a flap door configured to be relatively easily mechanically lifted off from and reattached onto the external surface. In an embodiment the at least a portion comprises all of the band-stop layer.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1-11. (canceled)

12. A bioprocess bag, for containing and protecting fluids involved in bioprocesses, the bag comprising:
at least two films that are bonded together along edges to form a bag; and a
fluid port through which to flow fluid into or out from the bag;
wherein at least one of the films is a multilayer band-stop film comprising a band-stop layer characterized by an electromagnetic (EM) transmission profile in at least a portion of the band-stop layer that blocks transmission in a selected EM bandwidth of EM radiation expected to be encountered in an ambient environment in which the bioprocess bag is to function that is inimical to a bioprocess liquid intended to be contained in the bag and wherein the band-stop layer is laminated to a surface of a layer in the multilayer band-stop film, which absent the band-stop layer would be an external surface of the bag, and comprises a flap door formed by a cut in the band-stop layer that is relatively easily mechanically lifted off from and reattached onto the external surface.

13. The bioprocess bag according to claim 12 wherein the EM transmission profile has a relatively high reflectivity for EM radiation in the selected EM bandwidth.

14. The bioprocess bag according to claim 12 wherein the EM transmission profile has a relatively low transmissivity for EM radiation in the selected EM bandwidth.

15. The bioprocess bag according to claim 12 wherein the EM transmission profile has a relatively high transmissivity for EM radiation in a band-pass window for which EM radiation is not inimical to the bioprocess liquid.

16. The bioprocess bag according to claim 15 wherein the non-inimical EM radiation comprises optical radiation in the visible spectrum.

17. The bioprocess bag according to claim 12 wherein the EM transmission profile has a relatively high transmissivity for EM radiation in a relatively narrow band-pass window for which EM radiation is inimical to the bioprocess liquid.

18. The bioprocess bag according to claim 12 wherein the inimical radiation EM comprises optical radiation in the visible spectrum.

19. The bioprocess bag according to claim 12 wherein the at least a portion comprises all of the band-stop layer.

20. The bioprocess bag according to claim 12 wherein the fluid port is bonded to the band-stop film.

21. A multilayer band-stop film comprising a band-stop layer characterized by an electromagnetic (EM) transmission profile in at least a portion of the band-stop layer that blocks transmission of EM radiation in a selected EM bandwidth of EM radiation expected to be encountered in an ambient environment in which the film is to function that is inimical to a bioprocess liquid with which the film is intended to be used wherein the band-stop layer is laminated to a surface of the multilayer band-stop film, which absent the band-stop layer would be an external surface of the multi player band-stop film, and comprises a flap door formed by a cut in the band-stop layer that is relatively easily mechanically lifted off from and reattached onto the external surface.

22. The band-stop film according to claim 21 wherein the at least a portion comprises all of the band-stop layer.
